(19) United States
(12) Patent Application Publication
(10) Pub. No.: US 2008/0055043 A1
(43) Pub. Date: Mar. 6, 2008

(54) RAILROAD YARD INVENTORY CONTROL SYSTEM

(75) Inventors: Richard Bruce Webb, Pittsburg, KS (US); Cheryl Sue Correll, Girard, KS (US); Terrance Daniel Towner, Pittsburg, KS (US); Jerry Deane Crane, Anderson, SC (US)

Correspondence Address: ERICKSON & KLEYPAS, L.L.C., 800 W. 47TH STREET, SUITE 401, KANSAS CITY, MO, 64112, US

(73) Assignee: WATCO COMPANIES, INC., Pittsburg, KS (US)

(21) Appl. No.: 11/832,641

(22) Filed: Aug. 1, 2007

Related U.S. Application Data
(60) Provisional application No. 60/821,130, filed on Aug. 1, 2006.

(51) Int. Cl. H04Q 5/22; G08B 13/14

(52) U.S. Cl. 340/10.1; 340/10.3; 340/572.1

(57) ABSTRACT

A system for tracking railcar identification and location within a rail yard including readers positioned near rail yard switches and remotely connected to a system data processing computer, typically a PC. The readers include antennas for interrogating RFID tags attached to railcars with radio waves. Identification data obtained from the RFID tags is transmitted from the readers to the system PC via electrical power lines within the rail yard. Processing of the data to standard T-94 format is shifted from the readers to the system PC thereby reducing the processing capability required at each reader.

### CROSS REFERENCE TO RELATED APPLICATION

This application claims the benefit of the prior filed, co-pending provisional patent application Ser. No. 60/821,130, filed Aug. 1, 2006, which is hereby incorporated by reference.

### BACKGROUND OF THE INVENTION

1. Field of the Invention

The present invention relates generally to railroad yards and, more particularly, to systems for tracking railcars within railroad yards

2. Description of the Related Art

Railroad yards, or rail yards, function as hubs within a railroad transportation system. Services provided in a rail yard include freight origination, interchange, and termination, locomotive storage and maintenance, assembly and inspection of new trains, servicing the trains running through the facility, inspection and maintenance of railcars, and railcar storage. The rail yard is made up of track segments interconnected by switches.

When a train enters a rail yard, one or more railcars may be removed from the train and other railcars added, depending on the train route and the ultimate destination of the railcars. Therefore, the particular composition of a train will change as it enters and leaves each rail yard. Because individual railcars in a train may have different points of departure and different destinations, it is critical that each railcar in a train be identified and tracked.

Identification scanners are typically located on tracks leading into and out of major rail centers to positively confirm the identity of railcars entering or leaving the rail yard. Positive identification of railcars by identification number enables maintenance of accurate rail yard inventory.

The problem with determining the positions of railcars within a track system has been addressed through the use of automatic railcar identification systems. Indicia comprising colored markings have been placed on the sides of railcars as a form of unique identifier. A scanner positioned beside a section of track senses the marking as the railcar passes the scanner. The scanner generates electrical signals corresponding to the identification coded by the color markings. The signals are decoded, stored and processed by a data processing computer. This method of using color markings on railcars is typically referred to as an ACI System.

More recently, railcars have been equipped with radio frequency identification (RFID) tags in lieu of ACI tags. Typically, passive RFID tags are used. Passive RFID tags do not contain a battery, rather, power is supplied by a carrier wave emitted by a tag reader positioned proximate to a railroad track. Radio waves emitted from the reader energize the coiled antenna within the tag and form a magnetic field. The magnetic field produces sufficient electrical power to energize the tag circuitry. Most passive RFID tags use backscatter to communicate information encoded in the tag circuitry to the reader. Rather than produce its own carrier wave, the tag modulates the reader carrier wave, reflecting the modulated wave back to the reader. The modulated wave thereby transmits a unique identifier, such as a serial number, or other information stored within the tag.

RFID tags used with railcars are typically known as automated equipment identification (AEI) tags. As with ACI systems, AEI readers may be positioned alongside track segments leading into and out of rail yards to read the tags. Railcar identification codes (IDs) stored within the tags are read by a reader when AEI-tagged railcars pass through a radio carrier wave field generated by the reader antenna(s). The railcar IDs are decoded and processed by the reader to a format specified by the Association of American Railroads. The reader either transmits the processed information to a central system each time an AEI tagged railcar passes or stores the information in a buffer for later transmission.

RFID tags are often preferred over optical tags, such as ACI tags, because RFID tags can be read at greater distances and the ability of a reader to scan an RFID tag is not substantially degraded if the tag moves past the reader at a high rate of speed. RFID tags employed in AEI systems for use on railcars may be used to identify and provide additional data about individual railcars in a train. The Association of American Railroads, Mechanical Division, has published a standard for automatic equipment identification, standard S-918-95, that identifies the requirements for RFID tags and readers employed by trains and specifies RFID tag data content and format.

The cost of identification scanners, including ACI and AEI scanners and readers, typically prohibits their use throughout a rail yard. Rather, other secondary sensors, such as wheel sensors, are used to alert the system to movement of railcars within the rail yard and between identification scanners. Typically, secondary wheel sensors are placed at both segments of the track leading from a split or three way junction. In addition to wheel sensors, direction of railcar travel within a rail yard may be determined by prior knowledge or record of direction of travel plus switch position at a down line junction which will determine the track that the railcar is moving onto.

Identification sensors read the railcars in a train and build a table or list of IDs in the order that they were scanned. This may be referred to as a train consist. Based on the order of IDs in a consist, and the order of scans recorded by secondary scanners, the railcars located on each track segment are known to the system, as are subsequent railcar movements.

Despite the use of secondary, non-identifying sensors, such as wheel rotation sensors, ACI and AEI systems remain quite expensive and can be an economic burden to install and maintain, particularly for small rail yards. Therefore, what is needed is a railcar identification system that provides low cost railcar identification readers that are less expensive to purchase, install, and maintain; thereby enabling greater use of readers throughout rail yard and yielding more precise and positive identification of railcars at multiple points within a rail yard.

Power line communication, also called broad band over power line communication, uses power line transceivers to send and receive electrical signals over present electrical power line networks. Data is typically transmitted by superimposing an analog signal over the standard alternating current. Broad band over power line communication uses power line communication technology, for example, to provide broad band internet access through ordinary electrical power lines. An improved railcar inventory system may, therefore, use power line communication technology to communicate between readers in a rail yard and remote central computer by interfacing both the reader and the remote computer to power line transmission modems.

### SUMMARY OF THE INVENTION

A system for tracking railcars includes a central system data processing computer that receives railcar identification and location data, and an RFID tag attached to a railcar, including an antenna and cooperating circuitry, that modulates a system-generated radio frequency carrier signal, thereby transmitting data stored in the tag. The system further includes an RFID tag reader positioned proximate to a section of railroad track that reads RFID tags attached to railcars as they pass the reader. The reader includes an antenna that broadcasts a radio frequency carrier signal, a radio frequency generating circuit that generates the carrier signal, a radio frequency receiving circuit that receives a radio frequency signal modulated by the RFID tag and decodes railcar identification data transmitted by the modulated signal, a control circuit that generates railcar location data and processes the location and identification data to generate a data transmission packet, and a transmission circuit interfaced with an electrical power line that transmits the data packet over the power line to the remote system data processing computer.

A receiving circuit for interfaced with the power line is located at the system data processing computer. The receiving circuit receives data packets transmitted over the power line and conveys the data packets to the computer. Software resident on the computer unpacks the data packet and stores the railcar location data and identification data in a computer database. The software also provides for the selective display of location and identification data through a computer graphic user interface. Processing of the data to standard T-94 format is shifted from the readers to the system PC, thereby reducing the processing capability required at each reader

### BRIEF DESCRIPTION OF THE DRAWINGS

FIG. 1 is a diagram of a rail yard showing a main line and branching track segments.

FIG. 2 is a diagram of a rail yard showing readers placed to scan railcars entering and leaving the rail yard.

FIG. 3 is a diagram of a rail yard showing readers with bi-directional antenna arrays positioned to scan adjacent track segments.

FIG. 4 is a diagram of a system PC graphic user interface.

FIG. 5 is an elevational diagram of a reader positioned proximate to adjacent track segments.

FIG. 6 is a diagrammatical representation of a reader schematic.

FIG. 7 is a diagrammatical representation of a controller schematic.

FIG. 8 is a diagram showing connections between major system data transmission components.

FIG. 9 is a diagram showing connections between major system data transmission components.

FIG. 10 is a diagram showing major software components related to receiving and processing data at the system PC.

FIG. 11 is diagram of an embodiment of a railcar tag monitor system.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

Referring to the drawings in more detail, the reference number 1 generally designates a railroad yard inventory control system according to the present invention. The system 1 tracks the location of specific railcars or locomotives 3 within a rail yard 10 using radio frequency readers, which may be uni-directional readers 60 or bi-directional readers, positioned at selected locations proximate to track segments within the rail yard 10. The readers scan radio frequency identification (RFID) tags 11 attached to the railcars or locomotives 3 (hereinafter referred to collectively as railcars 3) and transmit railcar identification information to a central database and processing computer 90. Wheel sensors 85 may also be used to further establish location and direction of movement of railcars 3 within the rail yard 10. The preferred database and processing computer 90 comprises an appropriately configured personal computer (PC) located within the rail yard 10. Railcar identification and location information are maintained by track segment on the database and may be displayed graphically or textually on the PC screen or on a client PC. The database may be queried by users, typically via standard SQL queries, to provide reports of railcar identification and location for viewing, printing or for export or access to or by other systems. Reports may be formatted to follow AAR S-918A specifications.

Rail Yard Layout

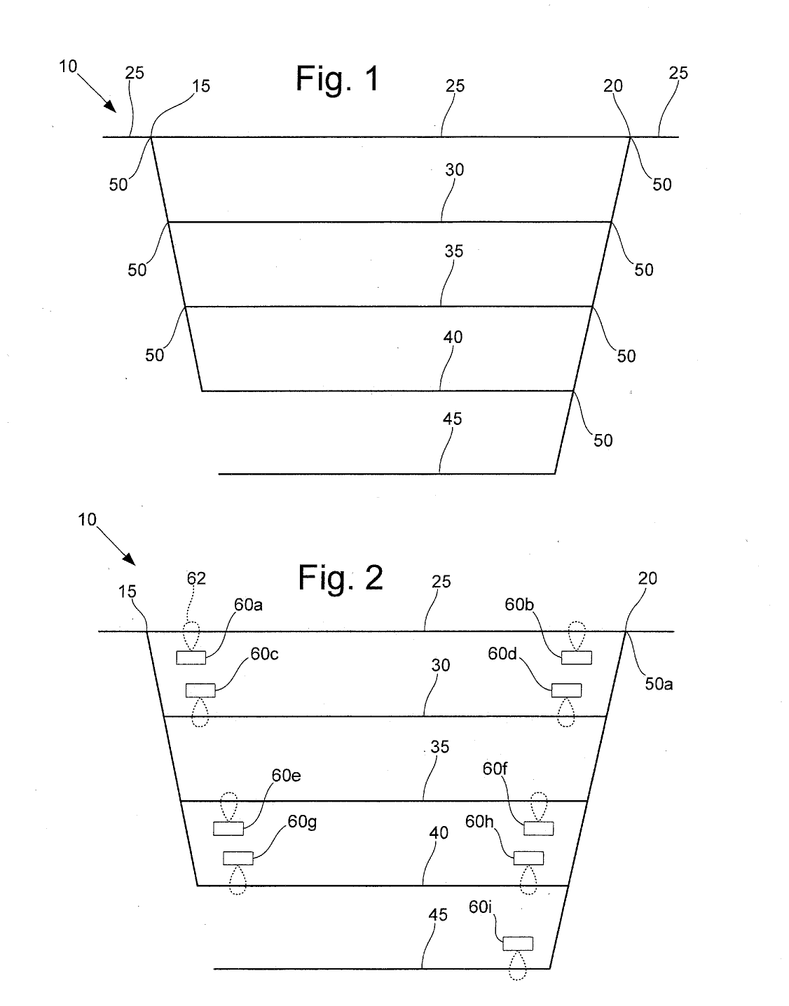

Referring now to FIG. 1 of the drawings, there is shown in diagram a typical rail yard 10 in a simplified configuration. The rail yard 10 includes sets or segments of tracks 25, 30, 35, 40 and 45 interconnected with one another to allow railcar movement among the segments. Movement of railcars 3 is directed by switches positioned at junctures 50 between the track segments. In particular, rail yard 10 track segments are configured to allow removal of railcars 3 from a given train consist for temporary storage or for rearrangement and sorting to form a new train consist. Switches controlled by a rail yard operator, or automated control system, direct particular railcars 3, or portions of a consist, to a particular track segment.

The rail yard 10 typically has an exit point 15 and an entry point 20 in communication with a main line 25. A train consist entering the rail yard 10 at entry point 20 may therefore be reconfigured by switching the locomotive and associated railcars 3 to any of segments 30, 35, 40, or 45 for holding or reconfiguration of a consist. Reconfiguration may occur by moving railcar positions and, typically, by adding railcars 3 already held on one or more segments, while leaving railcars 3 previously associated with the train for later attachment to future train consists. In this manner, railcars 3 traveling in a given train may be separated and assigned to other trains in accordance with routes required to attain various railcar destinations.

Railcars 3 are often provided with identification means such as RFID tags 11. RFID tags 11 include a circuit for storing data such as an identification serial number associated with a particular railcar 3 and an antenna for receiving radio signals and transferring electrical energy from the radio signals to the circuit to energize the circuit. Upon energization, the circuit relays the data stored therein to a reader 60 by modulating the radio signal received from the reader 60. Each railcar 3 typically has two tags 11, with one being positioned on each side of the railcar.

In order to interrogate or scan RFID tags 11 attached to railcars 3, RFID readers 60 designated as readers 60a through 60i may be positioned proximate to the main line 25 and track segments 30 through 45 as shown in FIG. 2. The directional antennas associated with readers 60a and 60b are oriented to read tags of railcars on the main line 25, while readers 60c and 60b are oriented to read RFID tags on track segment 30. Likewise, readers 60e and 60f are oriented to read track segment 35, while readers 60g and 60h read track segment 40. Reader 60i is positioned to read railcar tags on track segment 45. With readers 60 positioned as indicated, a train entering the rail yard 10 at entry point 20 will pass reader 60b if the switch at juncture 50a is set to direct rail traffic through the yard along the main line 25. If the switch at juncture 50a directs the train to another track segment within the yard, however, the train will pass either reader 60d, 60f, 60h, or 60i at which point RFID tags 11 attached to any of the railcars 3 forming part of the train may be interrogated. The readers 60 may be used, therefore, to isolate the location of a railcar 3 bearing a particular RFID tag 11 to a particular track segment within the rail yard 10.

The readers 60 are adapted to interrogate RFID tags 11 by broadcasting a radio signal of appropriate signal strength, amplitude and frequency to energize the antenna and associated circuitry sufficiently to cause the RFID tag 11 to release a return signal encoded with information-typically coded identification information associated with the railcar to which the RFID tag 11 is attached.

Readers 60b, 60d, 60f, 60h, 60i, that indicate the entrance of a railcar onto an associated track segment (25, 30, 35, 40, 45, see FIG. 2) within a rail yard 10 may also indicate when a railcar 3 leaves the segment if a second scan is taken of a particular railcar 3 without intervening scans by other readers 60. This would indicate a railcar 3 being backed out of a rail segment in the same direction from which it entered. More commonly, a railcar will be noted as having left a track segment when a scan is read by readers 60a, 60c, 60e, 60g positioned at opposite ends of the above segments.

A pair of readers 60 may also be positioned on opposite sides of a track segment, particularly the main line 25, to cover situations where one of the tags 11 on a car is inoperative or unreadable. A comparison between readings taken from opposite sides of the cars can identify railcars 3 which would otherwise not be identified.

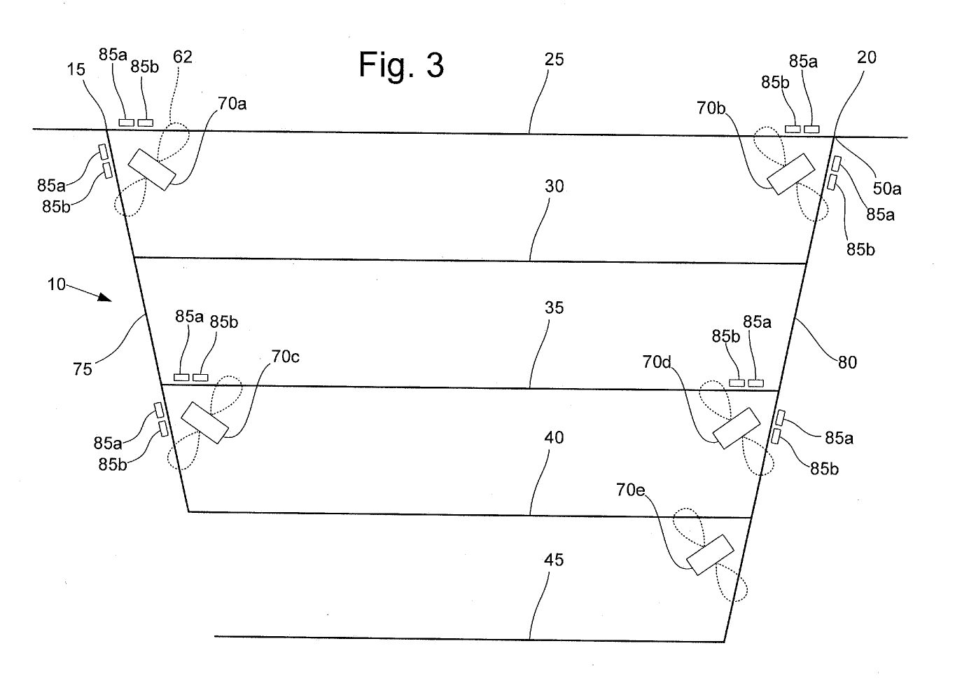

Alternatively, as shown in FIG. 3, the readers may be bi-directional readers positioned at locations proximate to adjacent track segments so that both adjacent segments can be scanned by the same reader. In this case, each reader 70 (which are designated as readers 70a-70e) includes two directional antennas and a multiplexer for receiving signals from each antenna and delivering them to a common processor within the reader 70. Through the arrangement of bi-directional readers 70a-70e, all track segments may be monitored. Readers 70a and 70b monitor the main line 25 and segments 75 and 80, respectively, that connect the main line 25 to the other segments 30-45.

Zones in which a directional radio signal generated by a reader antenna may effectively interrogate an RFID, are indicated in the figures by balloon or teardrop shaped symbols (for example, see zone 62 in FIG. 2 or 3) projecting from the rectangular symbols used to indicate readers. Such zones are also referred to as reader signals. It should be appreciated that such symbols are not drawn to scale but are provided merely to indicate that each antenna has a restricted effective zone of operability. In reference to their orientation in the figures, reader signals associated with reader antennas are referred to as upper signals or lower signals, or as the upper side or lower side of a reader.

With further reference to FIG. 3, if a railcar RFID is detected by reader 70b, upper side, and not by reader 70a, upper side, it may be presumed and recorded by the system that the railcar is located on the mainline 25. If reader 70b, lower side, detects a railcar RFID signal it may be recorded by the system that the railcar is on track segment 80 until a further signal is detected.

Location by the system of railcars within the rail yard 10 illustrated in FIG. 3 may transpire as follows. If track segments 75 and 80 are not used for railcar storage but solely to wrap railcars to segments 30 through 45, then a railcar initially detected by either 70a or 70b, lower side, may be presumed to be routed to segment 30 if a subsequent reading by 70c-70e is not detected within a set time period. If a railcar is detected by 70b, lower side, and then by 70d, upper side, the railcar is located on segment 35, if by 70e, upper side, 40, if by 70e, lower side, 45. Note that reader 70e may be a uni-directional reader set to scan only segment 45. In that case, detection of a railcar by 70e would place the railcar on segment 45, while detection of a railcar by 70d, lower side, without detection by 70e would place the railcar on segment 40.

This distribution of readers 70 offers the advantage of facilitating railcar tracking within a rail yard 10 while cutting the number of readers, relative to the distribution of uni-directional readers 60 shown in FIG. 2, by almost half.

While railcar entry, movement within, and exit from the rail yard 10 may be accurately determined if either (a) the rail yard 10 contents and locations are known at the time the system 1 is initiated, or (b) the yard 10 is empty of railcars 3 at such time, and the system 1 is active and fully functional at all times during railcar movement, such may not be the case in all installations.

The system 1, therefore, may be augmented by placing pairs of wheel sensors 85 on track segments to detect railcar passage and direction. Directional information may be obtained by placing the wheel sensors 85 in sequence so that a railcar wheel passes one sensor of a pair prior to passing the other sensor. The system 1 may thereby determine railcar direction of travel simply by noting which sensor was activated first. It is advantageous if a pair of sensors 85 are placed in front of a reader 60 or 70, based on the anticipated direction of travel, so that the wheel sensors 85 may be used to alert the reader to the presence of a passing railcar 3. A reader multiplexer circuit may thereby be switched to receive or pass signals coming from the antenna directed to scan the segment of track associated with the activated wheel sensor 85. As the rail yard 10 is emptied of railcars that enter the yard prior to initiation of the system, the records in the system data base will come to more closely reflect the actual status of the rail yard railcar inventory and locations. As an alternative to placement of wheel sensors 85 proximate to each reader, sensors may be placed only in proximity to entry/exit points 15 and 20 to confirm direction of entry into the yard 10.

Wheel sensors 85 also function to fill in gaps where railcars have inoperative or unreadable tags 11. The system will report missed cars when four axles have been sensed by the wheel sensors and no tags have been read. It will report the missed cars as equipment with an initial of “XXXX” and equipment number as “99999” or a random number.

Readers

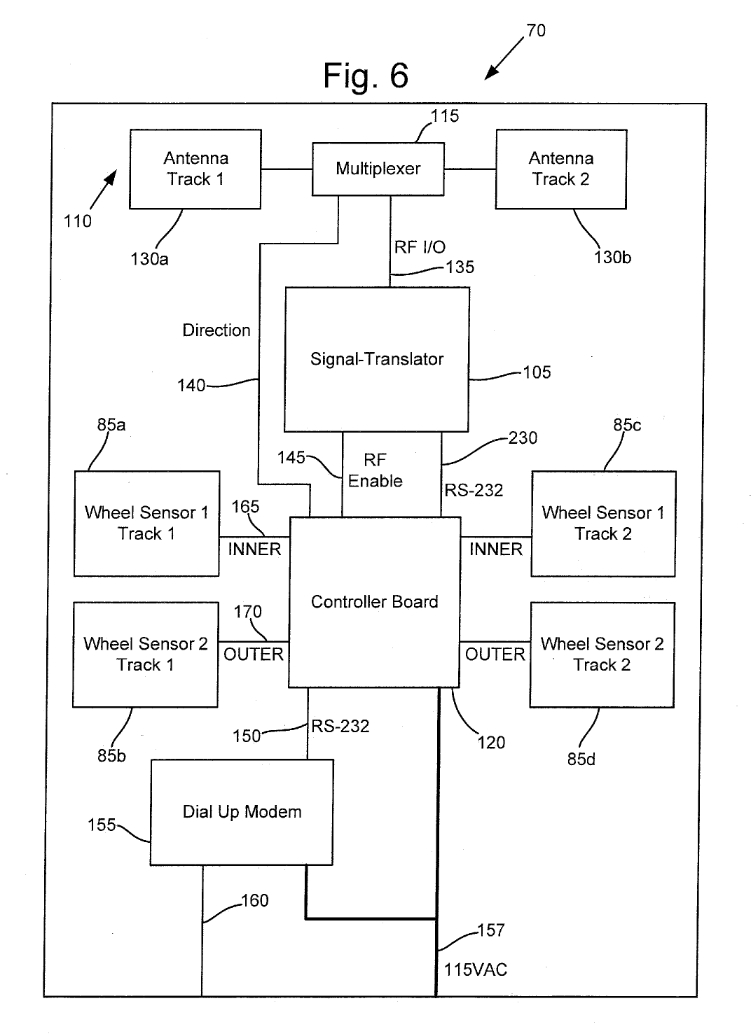

Referring to FIG. 6, an embodiment of a reader 70 is comprised of three major elements, (1) signal translation circuitry, such as a signal-translation processor 105 (for example, a TransCore® AI1620 board set provided by TransCore, a unit of Roper Industries, Hummelstown, Pa.) for translating radio signals received form an interrogated RFID into text-based character encoding, (2) an antenna array 110 with an associated switch (multiplexer) 115, and (3) a controller board 120. The controller board 120 provides power for the signal-translation processor 105, interface circuitry for wheel sensors 85a, 85b, 85c, and 85d (85 collectively), logic for controlling the antenna array 110, logic for control and supervision of the signal-translation processor 105, and acts as a communications gateway for the reader 70 to the main PC 90. A diagram of a uni-directional reader 60 (not shown) would be similar except that only a single antenna 130 would be used

The signal-translation processor 105 assembles data packets for transmission to the system PC 90 by translating the 120 bit data pattern received from an interrogated RFID into an ASCII stream with the translated data allocated to fields. ASCII is a text-based character encoding. Preferably, the fields correspond to, or are in conformance with, relevant AAR specifications. No further processing of the data is performed at the reader 60 or 70; rather, the ASCII data stream is transmitted, as described below, to the system PC 90.

The signal-translation processor 105 preferably includes a real time clock and a self-test function that are used to time stamp railcar tag data and to transmit periodic self-test results to the central PC 90 to monitor connectivity. Typically, the real time clocks on the board are synchronized with the real time clock of the PC 90 each day to maintain synchronization of the time stamps. The signal-translation processor 105 interfaces to the antennas 130a and 130b (collectively 130) through a radio frequency (RF) multiplexer 115 that allows the two antennas 130 to share the same RF feed.

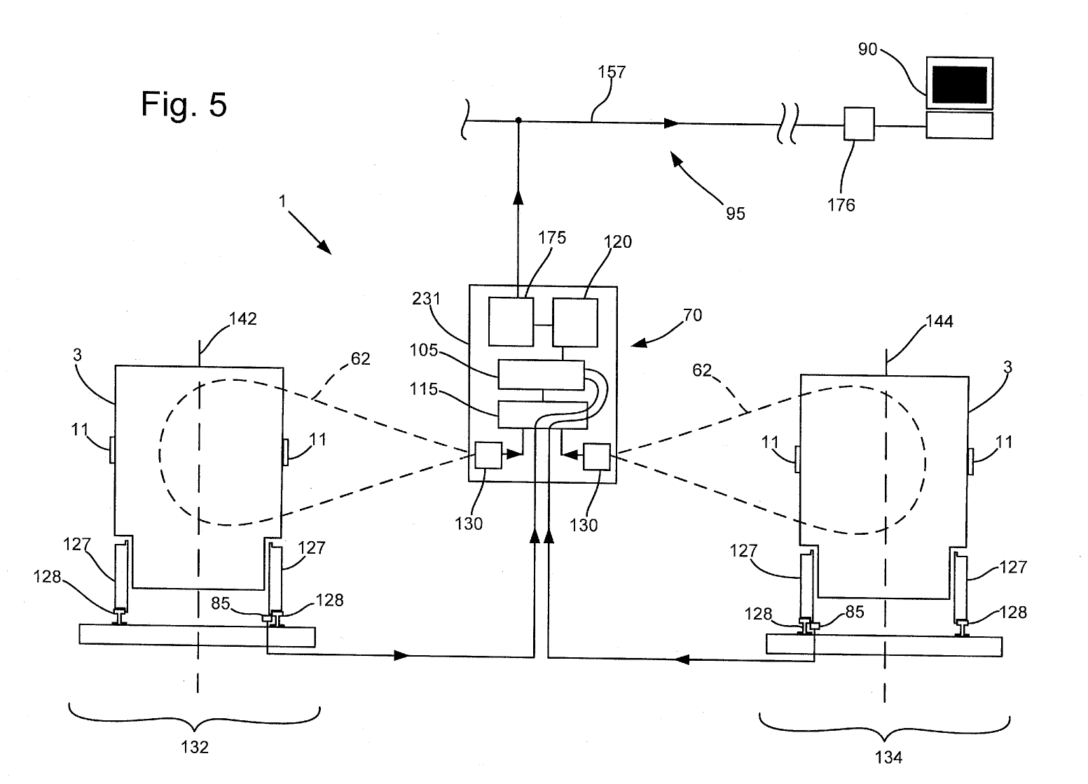

When a single reader 70 is provided with two directional antennas 130 in order to monitor adjacent track segments 132 and 134 (see FIG. 5), the reader 70 includes a multiplexer circuit 115 for switching the radio frequency I/O 135 to the signal-translation processor 105 between the two antennas 130. Control of the antenna selection is provided by the controller board 120 and is based on either time interval (time division) multiplexing, wheel sensor 85 activity detected on a track segment proximate to an antenna 130, or a combination of both types of selection and control means. In the case where time division multiplexing is used, the controller 120 periodically enables RF output from the signal-translation processor 105. If no tag 11 is sensed, then the RF signal will terminate until another timed cycle begins. If a tag 11 is sensed, then the tag data is read by the reader 70 and sent to the system PC 90. In the case of a defective tag 11, a presence-without-data message is sent to the system PC 90.

The second mode of controlling activation (RF transmission and reception) between two antennas 130a and 130b is via direct wheel sensor 85 input. In this mode, the reader 70 will activate the antenna 130 associated with a wheel sensor 85 that has detected the presence of a railcar wheel 127. If no tag 11 is detected, then the RF transmission will cease until another timed cycle or wheel sensor 85 input. If a tag 11 is sensed, then either the tag data or a presence without data message is sent to the system PC 90.

The controller board circuit 120 provides the power supply for the reader 70, control of the antenna multiplexer 115, and typically monitors up to four inductive pickup or laser wheel sensors 85. The power supply on the controller board 120 provides appropriate electrical power to all of the circuits and components comprising the reader 100. The signal-translation processor 105 is powered by 24 volts DC, the wheel sensors 85 are powered by a separate 24 volt DC rail, and the controller 120 itself requires 5 volts DC and 16 volts DC.

The controller board 120 controls which antenna 130 is activated based on input by a wheel sensor 85, timed multiplexing, or a combination of the two. As indicated in FIG. 6, the signal-translation processor 105 is controlled by two outputs from the controller 120. The first is a Direction signal 140 that controls which antenna 130 is connected to the reader's radio RF input/output (RF I/O) 135, and the second is an RF Enable signal 145 that commands the signal-translation processor 105 to activate the RF transmission. Termination of the RF transmission can be controlled remotely through system software sending appropriate instructions to the reader 70 or within the reader itself by a time-out within the controller 120.

The controller 120 also functions as a communication gateway between the reader 60 or 70 and the central PC 90, providing two separate communications interfaces to the PC: RS-232 communication 150 through a dial up modem 155, or transmission of data over existing power lines 157. Communication over power lines 157 is accomplished by converting RS-232 data, appending the data in the direction of travel, and sending data in a data stream to a power line transceiver (PLT) 175 (such as a PLT-22 provided by Echelon Corporation, San Jose, Calif.), which packages the data into a data packet for transmission to the central PC 180 (see FIG. 5). It is foreseen that other types of modems, such as cellular or satellite modems, could also be used.

Alternatively, the controller 120 may be configured to send a reader data packet via dial up modem 155 connected to a second serial port 150. When so configured, the controller 120 will initiate a communication session with the PC 90 over the modem 155 and will send packets from the reader to the PC over telephone lines 160 using a proprietary packet format. Typically, the controller 120 will maintain the modem connection for several seconds after the last data is transmitted after which it will end the connection. Any packets generated while a dial up session is not active are buffered within the controller's RAM until a connection can be made. The reader-to-PC dial up connection is configured during system installation for telephone number, login information, data transfer rates and data format.

The reader 60 or 70 is capable of providing direction-of-travel information if a track segment is monitored by two wheel sensors 85 connected to appropriate reader inputs In FIG. 6, the inputs 165 and 170 for each set of two sensors are labeled INNER and OUTER, respectively, such that the wheel sensor 85b that would be encountered first by a railcar wheel entering the track segment is connected to the OUTER input 170, and its paired wheel sensor 85a, that would be next encountered by the wheel, is connected to the INNER input 165. When the reader 60 or 70 receives a signal from the wheel sensor 85b connected to the OUTER input 170 followed by a signal from the wheel sensor 85a connected to the INNER input 165, the reader will determine and note to the system that the railcar direction of travel is IN. Likewise, when the INNER input 165 is activated prior to the OUTER input 170, the railcar direction of travel will be determined and noted as OUT. If only one signal is received, from either the INNER 165 input or OUTER 170 input, then the presence of a railcar may be noted but the direction of travel will either not be determined or will be noted as NONE or null.

Readers 60 or 70 are typically equipped with directional antennas 130 and are capable of reading railcar RFID tags within a certain distance depending on the characteristics of the particular reader and RFID tag. In the case of the readers 60 or 70 described herein, antennas 130 should generally be placed proximate to the track segment 132 or 134 to be monitored so that the reader will be within 10 feet of the track centerline 142 or 144 (see FIG. 5). Therefore, a reader 70 equipped with two antennas 130 is capable of reading RFID tags on railcars traveling on two separate, adjacent tracks 132, 134 if the tracks are within 20 feet of each other, measured center-line 142 to center-line 144. A reader 70 of the type described herein will typically read railcar RFID tags located up to 10 feet from the antenna face. FIG. 5 is an illustration (not to scale) of a reader 70 positioned proximate to the track segments 132 and 134 such that an RF signal 131 (of sufficient strength to interrogate an RFID tag 11) emanating from each antenna 130 projects at least to the track center lines 142 and 144. A reader 70 provided with two antennas 130 (bi-directional reader) also typically includes interface circuitry to support up to four wheel sensors 85, two for each track 132, 134 being monitored.

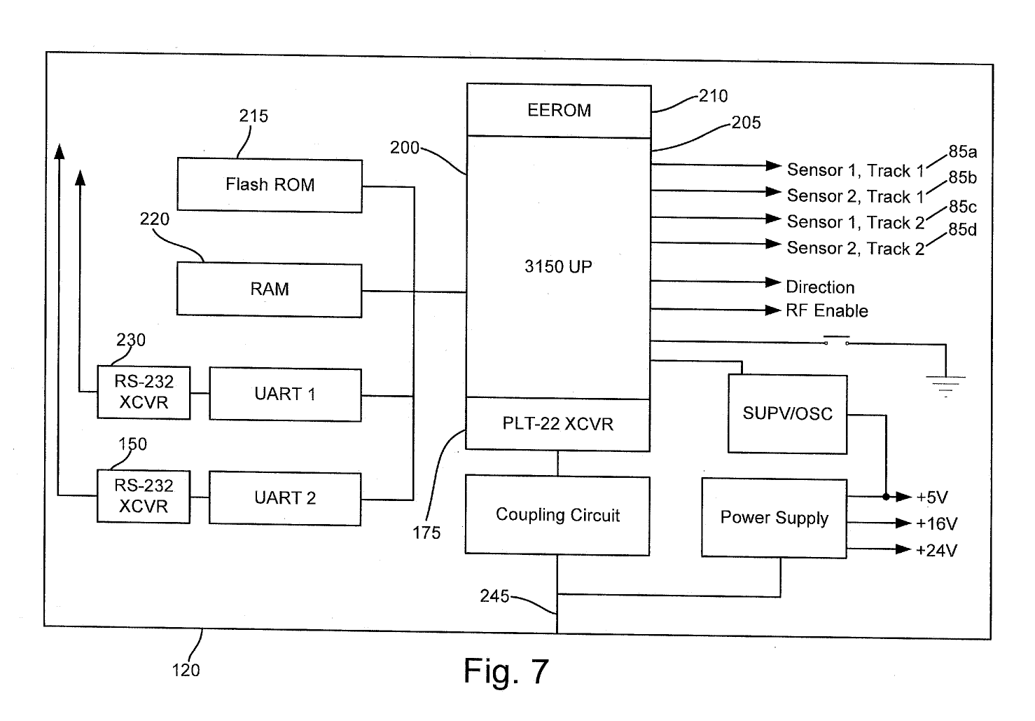

A block diagram of a controller board 120 is shown in FIG. 7. The controller is built around a processor 200, such as a 3150 Neuron processor 205 having 512 bytes of EEROM 210 used for storing configuration parameters. The controller 120 also has 64 Kb of Flash ROM 215 and 32 Kb of RAM 220. As configured in this embodiment, the controller 120 will support up to four wheel sensors 85a, 85b, 85c, and 85d. Typically, the wheel sensors 85 are configured two per track so that direction of travel of a railcar may be readily determined by sequence of wheel sensor 85 activation. Optionally, however, wheel sensors 85 may be deployed individually in which case the sensor 85 will merely alert the system to the presence of a railcar, without providing direction-of-travel.

The controller board 120 includes, or is interfaced to, three communication ports: two RS-232 ports 150 and 230 and a PLT-22 (power line transceiver) port 175. The first RS-232 port 150 connects the reader to the system PC 90 via the dial up modem 155 located within the reader 70 enclosure. The second RS-232 port 230 interfaces the controller board 120 with the signal-translation processor 105. Both of these RS-232 ports 150 and 230 support hardware flow control. The PLT-22 port 175 allows the reader to communicate with the system PC over the power line 157 that is used to supply electrical power to the reader.

The reader 60 or 70 is enclosed in a NEMA 4 enclosure 231 suitable for external use and that will allow for the antennas 130 to function properly, i.e. not substantially block or distort radio signals. Typically, the reader enclosure 231 is mounted on a pole in the rail yard. The reader operating temperature range is approximately 50° C. to −40° C. The reader is powered by a standard 115 volt AC, 60 Hz power supply, typically provided by the local electrical utility company. The voltage operating range is approximately 115 volts AC+/−10%. The power provided to a reader should be approximately 25 watts.

The reader 60 or 70 may be used in two operating modes designated as reader-to-host communications and host-to-reader communications. Regarding reader-to-host communications, as disclosed herein, the reader collects tag data from scanned railcar RFIDs 11 and railcar direction of travel data from associated wheel sensors 85 and appends such data to packets forwarded to the system PC 90. Further data processing is performed by the system PC 90, rather than at the reader 60 or 70, thereby reducing the hardware requirements for each reader and greatly reducing reader cost.

Packet payloads used to transmit data packets from the readers 60 or 70 to the system PC 90 may comprise the following fields: <antenna number>, <direction (i.e. direction of travel>, <SOM (i.e. start of message>, <data packet>, <EOM (i.e. end of message>. The data packets used in the embodiment described herein comprise an ASCII string with up to 72 characters. This string contains the tag data (i.e. railcar identification number), time and date of scan and auxiliary information. The data packet may comprise the following fields: <tag data>, time data delimiter (“&”), <hours (“HH”), time data separator (“:”), minutes (“MM”), time data separator (“:”), seconds (“SS”), time data separator (“:”), centiseconds (“hh”)>, <date delimiter (“0x20”)>, <month (“MM”), date data separator (“/”), date (“DD”), date data separator (“/”), year (“YY”)>, auxiliary data delimiter (“%”), <reader ID (“xx”), auxiliary data separator (“−”), antenna (“y”), auxiliary data separator (“−”), number of reads on previous tag (“zz”), auxiliary data separator (“−”), current status of I/O (“q”)>. Therefore, an exemplary data packet may take the following form: <tag data>&<HH:MM:SS:hh><0x20><MM/DD/YY>%<xx-y-zz-q>.

When the reader 60 or 70 is connected to the system via the power line transceiver 175, there is typically no need to buffer data and data packets are sent to the system PC 90 as they are received by the controller 120 from the signal-translation processor 105. When the reader 60 or 70 is connected to the system via dial up modem 155, the reader tests the connection prior to transmission of the data packet to determine if the connection is active. If not, the reader 60 or 70 will establish the connection and then transfer buffered reader data to the system PC 90. Once the buffer queue is empty, the reader 60 or 70 terminates the connection after a defined time-out period, if no new data is entered into the buffer queue during the time-out period. The value (duration) of the time-out period is between 0 and 255 seconds and is set by the system software typically resident on the system PC 90 during reader commissioning.

The reader 60 or 70 also has a mode in which it receives commands from the PC 90. The PC 90 may send configuration data to the reader to perform reader commissioning, read back the reader configuration to assure compliance with system configuration settings, invoke an internal tag self-test to execute, or send other communications to the controller 120 or signal-translation processor 105 such as commands or data used for maintenance diagnostics.

Reader commissioning occurs when the system software on the PC 90 sends commands and data to the reader 60 or 70 to set up the reader configuration. Parameters are sent from the PC 90 to the reader 60 or 70 to configure both the controller 120 and signal-translation processor 105. PC-to-reader communications is command-and-response oriented. Commands sent from the PC 90 to the reader 60 or 70 cause a response from the reader 60 or 70 to the PC 90. Although the packet wrapping may vary depending on the type of communication connection, the command packet payload is typically the same.

The following parameters are sent from the system software to the reader 60 or 70 as a command packet payload and stored in the controller 120 EEROM. The format of a system command packet payload is: !<command><bye count><data><EOM>.

Wheel Sensors

Appropriate wheel sensors 85 include inductive sensors provided by Honeywell Sensing and Control of Freeport, Ill. and Altech Corp. of Flemington, N.J., for example, the Honeywell RDS80001 and the Altech 9900. Inductive sensors sense the presence or absence of ferrous metal, and if properly located proximate to a rail, can be used to sense the presence or absence of a rail wheel flange. Typically, a sensor 85 provides an output current at a steady state that varies when a wheel flange enters into the sensor's 85 magnetic field. For example, it has been observed that sensors 85 used with the system provide an output current of approximately 4 mA when no wheel is present and an increased output of 20 mA when a wheel is positioned directly over the sensor 85. By detecting the change in current, therefore, the reader 60 or 70 can detect the presence of a railcar at the sensor location. By monitoring the relatively constant 4 mA output, the reader can detect sensor failure as exhibited by significant drop, or cessation, of current output. Because the electrical cabling from the reader 60 or 70 to the sensors is, of necessity, external to the reader enclosure and subject to electrical anomalies, the sensor input circuitry is galvanically isolated from the rest of the reader circuitry.

An alternative wheel sensor (not shown), operable in the present system, comprises a laser wheel sensor. Laser wheel sensors are mounted in pairs along a section of track 132 or 134 in a similar manner to the inductive pickup wheel sensors 85. The lasers of each sensor are oriented to the track so that the laser beams are broken by a passing wheel 127, first one beam, and then as the wheel 127 rolls further past the sensors, the other beam. By detecting which beam is broken first, the system may determine the direction of travel of a railcar passing the sensors along the monitored section of track.

Reader to PC Connection

The PC 90 is preferably connected to the readers 60 or 70 via a power line transceiver that is connected to one of the PC USB ports. The power line transceiver is coupled directly to the power distribution panel used to power the readers 70 with approximately 115 volts AC.

Referring to FIG. 5, the system PC 90 interfaces to a Power Line Communications Gateway (PLCG) 95 which operates to interface one of the PC communications ports to an electrical power line 157. The PLCG 95 may use a primary power line transceiver (PLT) 176 such as a LonWorks® PLT provided by Echelon Corporation. The primary PLT allows reliable data communications over electrical power lines typically used within commercial and residential buildings. In the U.S., the power lines typically carry a voltage of 115 AC. Typically, the PLCG 95 interfaces the power line used to provide electrical power to the PC. Reader PLTs 175 (see FIG. 7) are used to interface each reader 60 or 70 to the same power line network interfaced with the PC 90. Typically, the transceiver 176 used for interfacing the PC to the electrical power line system is the same type as the transceivers 175 used for interfacing readers to the electrical power line system. Once the readers 60 or 70 and the PC 90 are each interfaced to the electrical power line system, the readers 60 or 70 and the PC 90 may communicate with one another using electrical signals transmitted over the power line 157.

The wiring network for the power line cabling to the readers 60 or 70 may use a star or tree topology, however, the selected PLTs 175 and 176 may have cable length limitations. For example, LonWorks® PLTs from Echelon Corporation require a total cable length between any one reader PLT 175 and the primary PLT 176 to not exceed approximately 2000 meters. In addition, regardless of the supplier or brand of PLT used, it is generally important that no electrical transformers are present between any reader PLT 175 and the primary PLT 176

Alternatively, the PC 90 may also be connected to readers 60 or 70 through a dial up modem 155. The modem 155 is typically connected to a dedicated telephone line 160. Communication via dial up modem may be used to connect to readers 60 or 70 located outside of the rail yard 10 or to those powered by an electrical power line other than that used to power the PC 90.

System Computer

An appropriate central computer 90 may include a commercially available personal computer (PC) running a Microsoft Windows operating system such as Windows XP. It should be appreciated that the system PC may comprise more than one processing unit and may comprise a bank of personal computers including one or more system servers. It should be also be appreciated that both hardware and software, including the PC and operating system, may be upgraded as improved versions become available on the market.

The PC 90 preferably maintains a yard configuration database, a reader configuration database, and a rail yard train consist database. The yard configuration database describes the location and function of the readers 60 or 70 and identifies track segments with the readers that will monitor those track segments. There are three typical configurations for monitoring a track segment (a) a two-port segment with two readers, one located at each end of the segment, (b) a stub segment with one reader located at the entry point, and (c) a pass-through segment with two ports but with only one reader. The reader configuration database stores reader parameters which may include reader default settings, the number of tracks monitored by a given reader, wheel sensor information, and communication parameters. The rail yard train consist database includes data pertaining to individual track segments and railcars located on those segments.

The PC will take data from the readers and store it into the yard consist database. Periodically, or upon user request, the system generates a consist report from the yard consist database. The consist report is stored in a fixed location within a system directory to allow for client processes to gain access to the data. The consist reports are typically formatted to comply with AAR-918A specifications. This format is referred to as the “T-94” format. Because yard consists are very likely not actual train consists, but rather segments thereof, many of the fields in the “AEH segment message” will not contain data or will contain default values. For example, a yard consist may not include a locomotive. For pass-through segments, some of the data, such as train speed, will be omitted or set to defaults, since the system is designed primarily for yard locating. The AAR-918A specifications provide for exclusion of data in these circumstances.

The PC 90 may also transmit train consist reports offsite via Internet or other means.

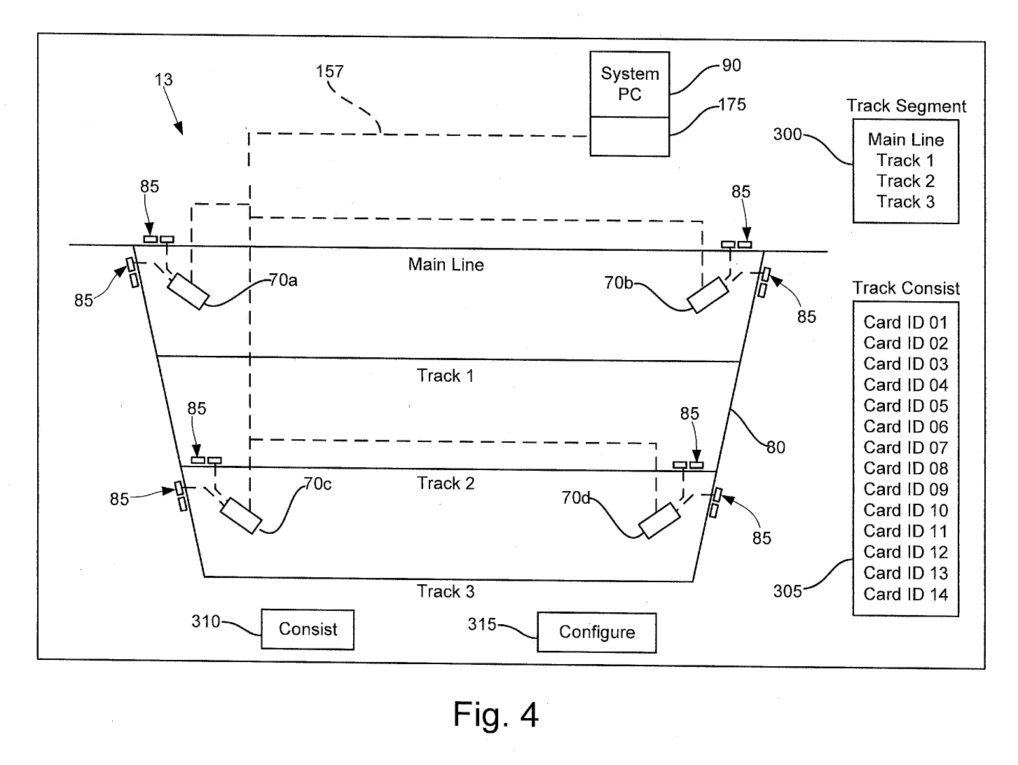

The system software resident on the central PC presents a graphic user interface whereby a user can readily locate data through selection of track segments and consists. FIG. 4 is a diagrammatical representation of a sample screen presentation provided by the system software running on the system PC 90. In addition to the graphical representation of the rail yard 10, readers 70, power/communication lines 157, and PC 90, the screen provides two menu boxes 300 and 305. The upper right box 300 lists track segments of the rail yard 10. A user may select a track segment of interest by clicking on a listed track segment name with the PC mouse cursor. The user may then click on the Consist button 310 at the lower, center portion of the screen to cause the lower right box 305 to display the associated track segment consist report. The user may click on the Configure button 315 to the right of the Consist button 310 to edit the track and/or reader configurations. The track segment consist report lists the railcars that comprise the consist in the order of their relative position to the first reader in the associated track segment configuration. For example, if Track Segment 2 in FIG. 4 is monitored by reader 70c to reader 70d, then the railcars will be listed by proximity to reader 70c with the railcar closest to reader 70c listed first. A number in parentheses besides the track segment identification number relates the number of railcars currently located on that individual track segment. For pass-through segments having only one reader 70, the track segment consist report shows the last train consist that passed and the first railcar in that consist will have its arrival time listed. Track consist and train consist reports are stored in fixed directories and may be viewed or printed or annotated using standard text editors such as Microsoft WordPad.

Operation

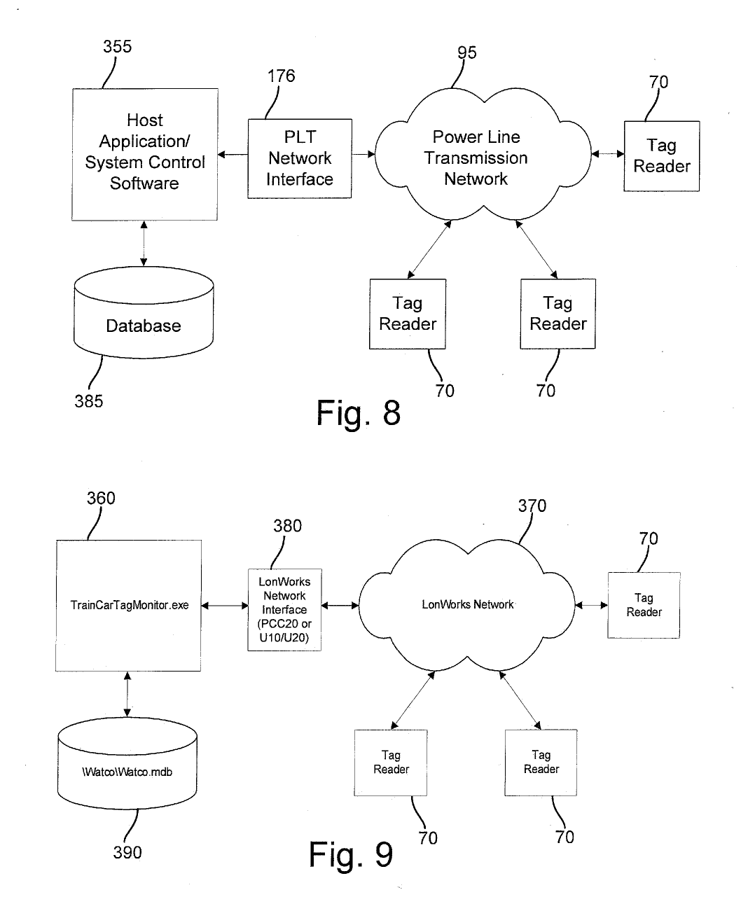

With reference to FIGS. 8 and 9, FIG. 8 disclosing the functions of certain major system components related to data transmission within the system, and FIG. 9 disclosing a specific embodiment, the tag readers (which will be referenced as bi-directional tag readers 70, but could alternatively be uni-directional tag readers 60) read the railcar RFID tags and detect wheel sensor status and forward valid tag information to the host application 355, i.e. system control software, such as the TrainCarTagMonitor program 360, via the power line data transmission network 95, e.g. the LonWorks® network 370. The LonWorks® network 370 is a power line network connected to an Echelon USB power line network interface, such as the LonWorks® network interface 380. The USB power line interface is controlled by the Echelon OpenLdv (LDV32.DLL).

The power line data transmission network interface 176, such as the LonWorks® network interface 380, provides connectivity between the system PC 90 (hosting the TrainCarTagMonitor Program 360) and the LonWorks® network 370. The TrainCarTagMonitor program 360 provides the actual monitoring of the train car RFID tags, generates consist reports, and stores and receives data to and from the database 385, e.g. the Watco.mdb database 390.

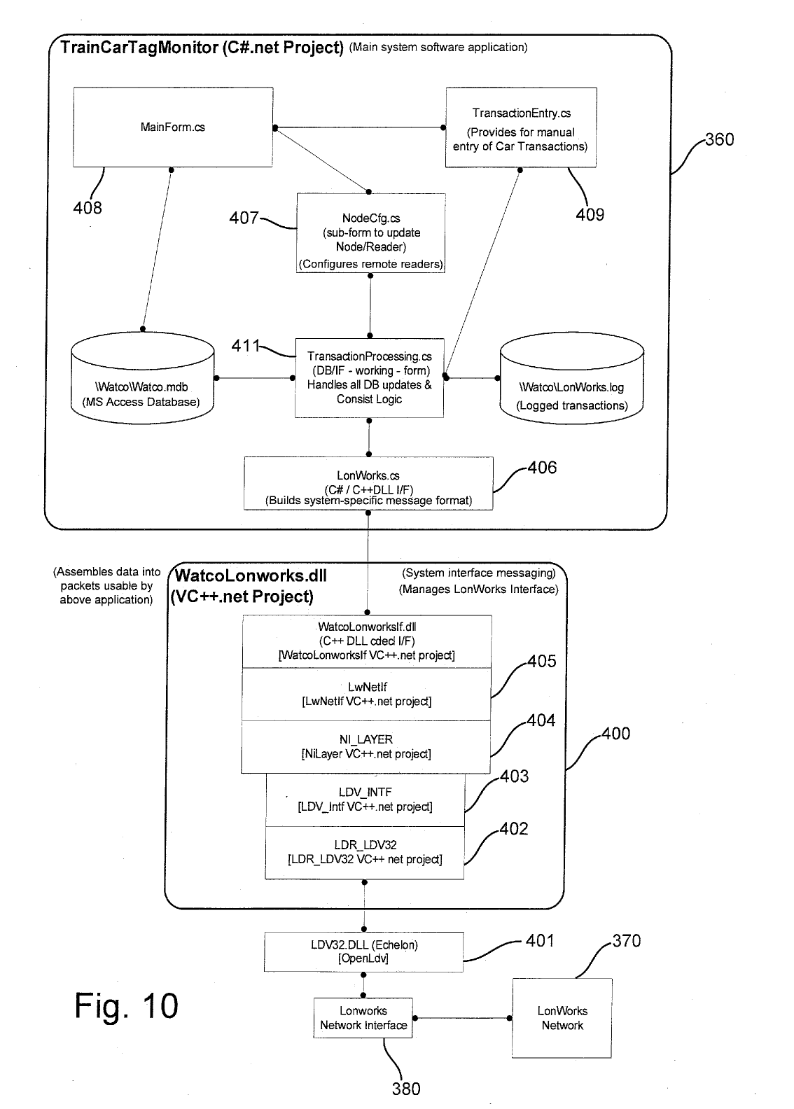

FIG. 10 shows a block diagram of the host application and related software used to operate the system. This block diagram does not show the tag readers 60 or 70, but it is connected to the LonWorks® network 370, which is in turn connected to the readers 60 or 70. The TrainCarTagMonitor program 360 communicates with the network interface 380 through a WatcoLonworks protocol stack 400 which assembles data from the network 370 into packets usable by the TrainCarTagMonitor program 360. The protocol stack 400 receives the data from the network interface 380 which is controlled by OpenLdv (LDV32.DLL) 401 from Echelon Corporation, which provides a software driver interface to the network interface adaptor 380.

The WatcoLonworks stack 400 provides a network packet protocol stack and network management. It can be categorized as a network stack that provides connectivity to LonWorks® devices from a PC application. This protocol stack is typically written in ‘C’. The detailed implementation of these programs is within the ability of one skilled in the art, and in particular one knowledgeable regarding Echelon faces.

The WatcoLonworks stack 400 includes the following subprograms:
402 Ldr_ldv32 Interface to the OpenLdv (LDV32.DLL) interface
403 Ldv_Inft Generic LonWorks® device interface
404 NiLayer Provides network interface layer, and
405 LwNetIf LonWorks® network interface—provides packet handling, and LonWorks® network management command interfaces.

The TrainCarTagMonitor program 360 provides all of the processing of the train car tags. It is responsible for reading car tags forwarded by the tag readers 60 or 70, and building train consists. The basic components of this program are:
406 LonWorks.cs: Provides an C# interface to the WatcoLonWorks.DLL 400 (C/C++).
407 NodeCfg.cs Provides a dialog to modify/update the configuration of the tag readers 60 or 70. Specifically, it allows the assignment of LonWorks Subnet/Node to the tag readers, as well as other configuration specific to the tag reader nodes.
408 MainForm.cs Provides the main form for the program. There is a section that allows a picture (bitmap) of the train yard, a status area, and two listboxes that contain the train segments and the current consist of the currently highlighted train segment's consist report.
409 TransactionUpdate.cs Provides manual entry/updating of car tags.
410 ConsistReport.cs Provides the base level consist report functions. Called by Transaction Processing.cs to build consist reports.
411 TransactionProcessing.cs Provides the main processing of car tags, and consist reports. The algorithm is described in the next section. This module contains all of the algorithms that determine the entry and/or exiting of segments, consist report buildings, and is the primary database interface.

LonWorks.cs 406 provides the interface between the LonWorks® network stack 400 and the actual Win32 (.NET) program. It also provides a timer that pulls up messages received from the LonWorks® network 370. When a valid message is received, it calls routines in the TransactionProcessing.cs module 411 to process the received messages.

The steps in the processing of a receive message are as follows:
1. LonWorks.cs:: LonWorksPumpMessages( )—timer based routine used to drive the WatcoLonWorks.dll stack, and call CheckForRxAppMessages( ).
2. LonWorks.cs:: CheckForRxAppMessages( )—routine to check for any new receive messages, and call RxCommandDispatcher( ) if so.
3. LonWorks.cs:: RxCommandDispatcher( )—routine to check the LonWorks® software command code for valid messages, and perform initial command processing. If the message is a car tag read, it calls PostItBySubnetNode( ).
4. TransactionProcessing.cs::PostItBySubnetNode( )—routine to convert from LonWorks® software Subnet/Node to ReaderId, and then call PostItByReaderId( ).
5. TransactionProcessing.cs::PostItByReaderId( )—routine to perform the 2 minute timeout check for the current car tag. It checks to see if there are any cars that are in the current segment of the just-read car tag and reader. If so, and if the indicated car is the second car in that segment on the same end, then the last in car is “pushed” out, and the new car tag is processed normally. In both cases, as appropriate, PostItByReaderIdSingleCar( ) is called to process the car tag.
6. TransactionProcessing.cs::PostItByReaderIdSingleCar( )—this is the main car tag processing routine. Its general algorithm is described below.

In general, the car tags have a status according to one of the following three status types: “I” for In/Entry, “O” for Out/Exit, and “N” for Undetermined. The first two status types are explicit in that they specify exactly what the car status is within the rail yard, whereas the latter requires an inference based upon the current location of the indicated car.

The “In” status indicates that a car is entering a segment. The car is removed from the segment in which the database indicates that it is currently located, and moved into the new segment indicated by the reader ID.

The “Out” status indicates that a car is exiting a segment. If the parent of the current segment is null, then the car is exiting the yard. If the parent of the current segment is not null, then the car is entering another segment.

The “N” status indicates that the car's new location is based on the current location in the yard. Although this logic is present within the software, it is not typically used since the wheel sensors allow the tag readers to provide an indication of direction.

Generated Files

Departure Consist: This directory contains departure consists for trains. A train is defined (for the purpose of this program) as one or more locomotives, with all cars in between, or the previous EndOf Train device through the just-exited EndOf Train device. Duplicate car entries are removed.

Entry Consist: This directory contains files that indicate the arrival time for the cars in the yard.

Log: This directory contains LonWorks® software messages that are received from the LonWorks® network. Note that manually entered car tags are not typically entered into this history file.

Segment Consist: This directory contains the current train consist reports for the segments that are defined. With each change in car location, the appropriate file(s) are updated in this directory.

Transactions: This directory contains all transactions that have occurred.

Additional System Capabilities

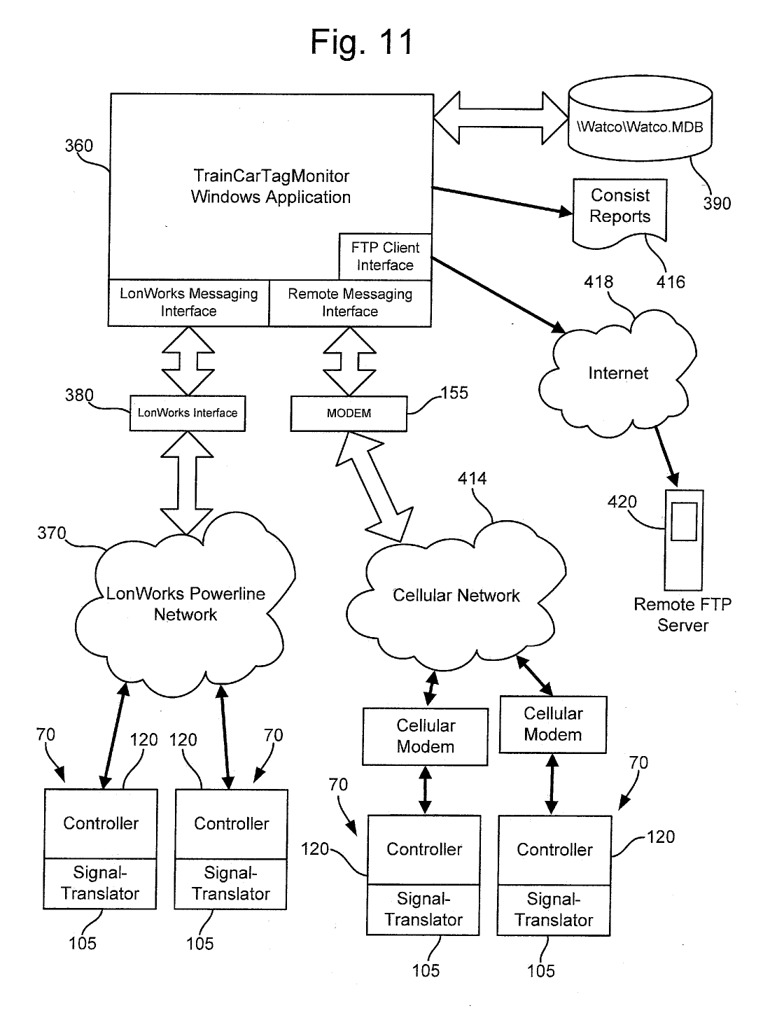

A reader 70 may include the ability to communicate with the system 1 via dial-up modem 155, cellular data modem 412, satellite modem (not shown), or power line transceiver 175. FIG. 11 illustrates communication with readers 70 over both a power line network 370 and over a cellular network 414. The system may include FTP client capability to transmit a train consist report 416 to a railcar operating system over the Internet 418 via FTP. The FTP method, address, user ID, and password are table-driven. The FTP methods are (1) FTP from the system application and store the T-94 file on an FTP server 420, or (2) store the T-94 file on the FTP server 420 for transmission by an external batch process. Such as system has the capability of transmitting to several, typically four, FTP host addresses.

The system monitors switch positions when the reader is positioned close to a switch and provides a screen to view the switch positions.

The system creates a train consist in standard T-94 format. The train consist is typically created following reading of an end-of-train (EOT) tag. If no EOT tag is read the system will create the train consist when 10 minutes has elapsed since the last car was read. Wheel sensors sense the direction of the train. The train consist is interpreted by the system as moving in the direction indicated by the majority of wheel sensor reads.

The system provides the ability to remotely monitor the operation of the antennas and other system components.

The system may include a software routine to automatically generate and transmit an email message if the system notes that there are railcars missing from the yard or from a consist or, if the car is being interchange delivered, the rail yard did not receive the railcar when expected.

The central system displays the railroad, readers, their status, the date and time of the last consists sent. The system allows selecting a track segment and then a reader to see a list of all consist dates and times from this reader. The system provides the ability to select and print these train consists in a readable form.

The system stores all train consists in a database for access by other applications. The data stored typically includes railroad, reader, equipment initial, equipment number, direction, date, time, date and time T-94 transmitted, and the order in the consist of the particular car.

The system includes a battery backup to allow 6 hours of operation when power is lost. The system transmits an alert when power is lost to the system to notify the electric utility.

If connectivity to the central system is lost, the system will typically store data related to up to the last 300 cars and transmit the data when connectivity is restored.

The yard locating system may provide sectional railcar tracking enabling cars to be located within defined sections. The sectional system typically includes all of the capabilities of the mainline system. The system provides a screen which shows all cars, and the date and time they arrived within a section, in order. The system also provides a lookup function to allow the entry of a car initial and number. The system will then show the section that the car is located in and the date and time it entered the section.

The system creates T-94 consists when cars enter and exit the section. The creation of the T-94 is parameter-driven and based on the section. The options may include:
1. Create the entry and exit consists when an EOT is detected or no car is read within 10 minutes.
2. Create an entry consist for each car entering the yard. Create an exit consist for each car exiting the yard.
   Reports and System Log File

The PC software will maintain a System Log File which will chronologically capture significant system events. These include changes in system configuration, car movements, error transactions, and any system errors. The log file will be stored in the same directory as all other reports to allow remote users FTP access to it.

The PC program will generate two types of reports. These reports will be stored in the same directory as the system log file and will be available for FTP access by remote users. The first type of report is a system configuration report which will provide a complete listing of the system configuration. This includes track segment definitions, reader configurations, and any other system related configuration The second type of report will be a consist report for each track segment. Each report will be in T-94 format. Note that the T-94 format assumes that a valid train consist exists and that the train is moving. In our case, the track consist will not necessarily be a valid train consist and there may be inconsistent directions of movement and/or there will be no movement/speed information available.

It is to be understood that while certain forms of the present invention have been illustrated and described herein, it is not to be limited to the specific forms or arrangement of parts described and shown. As used in the claims, identification of an element with an indefinite article “a” or “an” or the phrase “at least one” is intended to cover any device assembly including one or more of the elements at issue. Similarly, references to first and second elements is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

What is claimed and desired to be secured by Letters Patent is as follows:

1. A railroad yard inventory control system comprising:
a) a tag reader with a reader antenna and cooperating transmitting circuitry for transmitting carrier radio waves to a radio frequency identification tag on a railcar, said radio frequency identification tag comprising a tag antenna and cooperating data storage and radio frequency modulation circuitry for receiving and modulating said carrier radio waves, whereby data stored in said tag circuitry is transmitted via said modulated radio waves,
b) said tag reader further including cooperating receiving circuitry connected to said reader antenna for receiving said modulated radio waves from said radio frequency identification tag,
c) means for decoding railroad car data transmitted via said modulated radio waves,
d) a data processing computer remote from said tag reader; and
e) means for transmitting said decoded data to said remote data processing computer, said data processing computer including software for receiving said decoded data and processing said data to generate a listing of railroad cars associated with said railroad car data.

2. The rail yard inventory control system of claim 1 wherein said decoded data comprises railcar location data.

3. The rail yard inventory control system of claim 1 wherein said means for decoding data comprises means for assembling data packets for transmission to said remote data processing computer by translating electrical signals in said receiving circuitry corresponding to said modulated radio waves into ASCII code.

4. The rail yard inventory control system of claim 1 wherein said means for transmitting comprises a power line transceiver for transmitting said decoded data over an electrical power transmission line.

5. The rail yard inventory control system of claim 1 wherein said data processing computer comprises means for processing said decoded data into standard T-94 format.

6. The rail yard inventory control system as in claim 1 wherein said reader antenna is a first reader antenna directed toward a first track segment in a rail yard and said tag reader further includes a second reader antenna directed toward a second track segment in said rail yard.

7. The rail yard inventory control system as in claim 6 and further including multiplexer circuitry for switching said reader between said first reader antenna and said second reader antenna.

8. A rail yard inventory control system comprising:
a) a radio frequency identification tag reader, said reader comprising at least one antenna directed toward a respective track segment for generating a radio signal of sufficient intensity to interrogate a radio frequency identification tag on a railcar, said reader including means for decoding radio signals received from said tag into a data comprising computer-readable character encoding and means for assembling said decoded data into data packets,
b) at least one system computer remote from said tag reader; and
c) means for transmitting said data packets from said reader to said at least one system computer via a power line communications gateway.

9. The rail yard inventory control system of claim 8 wherein said means for transmitting said data packets to a remote system computer includes a first power line transceiver integral with said reader for transmitting said data packets over an electrical power line, an electrical power line interfaced with said first power line transceiver to receive said data packet from said first transceiver and carry said data packets to a remote second power line transceiver interfaced with said at least one system computer.

10. The rail yard inventory control system of claim 9 wherein said means for decoding includes:
a) signal-translation circuitry connected to said at least one antenna and operable to translate a radio signal received from said radio frequency identification tag into data packets in ASCII format; and
b) controller circuitry connected to said signal-translation circuitry and providing a communications gateway between said signal-translation circuitry and said first power line transceiver.

11. The rail yard inventory control system of claim 10 wherein said controller circuitry also receives input from at least one wheel sensor mounted proximate to said track section and integrates said wheel sensor input into said data packets.

12. The rail yard inventory control system of claim 11 wherein said at least one antenna includes a first antenna directed toward a first track segment and a second antenna directed toward a second track segment, said reader further including multiplexer circuitry operable to selectively connect either said first antenna or said second antenna to said reader circuitry, said multiplexer circuitry being controlled by said controller circuitry.

13. The rail yard inventory control system of claim 12 wherein said controller circuitry directs said multiplexer circuitry to switch communication with said reader circuitry between said first and second antennas in response to input from said at least one wheel sensor.

14. A rail yard inventory control system comprising:
a) a radio frequency identification tag reader, said reader comprising:
i) a first antenna directed toward a first track segment and a second antenna directed toward a second track segment, each of said antennas for generating a radio signal of sufficient intensity to interrogate a radio frequency identification tag on a railcar,
ii) signal-translation circuitry for decoding radio signals received from said tag into a data comprising computer-readable character encoding and means for assembling said decoded data into data packets,
iii) multiplexer circuitry selectively switching communication with said signal-translation circuitry between said first and second antennas;
iv) a first power line transceiver integral with said reader for transmitting said data packets over an electrical power line; and
v) controller circuitry controlling operation of said multiplexer circuitry and acting as a communications gateway between said signal-translation circuitry and said first power line transceiver;
b) at least one system computer remote from said tag reader; and
c) an electrical power line interfaced with said first power line transceiver to receive said data packet from said first transceiver and carry said data packets to a remote second power line transceiver interfaced with said at least one system computer.

15. The rail yard inventory control system of claim 14 wherein said controller circuitry also receives input from at least one wheel sensor mounted proximate to said track section and integrates said wheel sensor input into said data packets.

16. The rail yard inventory control system of claim 12 wherein said controller circuitry directs said multiplexer circuitry to switch communication with said reader circuitry between said first and second antennas in response to input from said at least one wheel sensor.
